(19) United States
(12) Patent Application Publication
(10) Pub. No.: US 2017/0109575 A1
(43) Pub. Date: Apr. 20, 2017

(54) SAFETY LABEL REPLICATION AND MANAGEMENT SYSTEMS

(71) Applicants: Robert W. Martell, Portland, OR (US); Kevin M. Parks, Canby, OR (US)

(72) Inventors: Robert W. Martell, Portland, OR (US); Kevin M. Parks, Canby, OR (US)

(21) Appl. No.: 15/294,236

(22) Filed: Oct. 14, 2016

Related U.S. Application Data
(60) Provisional application No. 62/241,416, filed on Oct. 14, 2015.

(51) Int. Cl. G06K 9/00; G06F 17/30; G06T 7/40; G06Q 50/26; G06Q 30/00; H04N 5/33

(52) U.S. Cl. CPC G06K 9/00463; G06Q 30/018; H04N 5/33; G06K 9/00469; G06T 7/408; G06Q 50/265; G06F 17/30268; H04N 5/232

(57) ABSTRACT

In one embodiment, a safety label management system includes a mobile device comprising a camera, a label database, a safety label printer configured to print safety labels, and a computing unit in electronic communication with the mobile device, the label database, and the safety label printer. The mobile device may be configured to capture, via the camera, an image of an existing safety label. The label database may store a plurality of database entries, each entry including a unique label ID number, a set of label characteristics, and a printable label file. The computing unit may be configured to: process the image to identity label characteristics of the existing safety label; compare the label characteristics of the existing safety label to the label characteristics of the label database entries; and prompt a user to perform an action.

### CROSS REFERENCE TO RELATED APPLICATIONS

This application claims priority to copending U.S. Application, Ser. No. 62/241,416, filed on Oct. 14, 2015, which is hereby incorporated by reference for all purposes.

### BACKGROUND

The present disclosure relates generally to safety labels. In particular, systems and methods for automatically replicating, updating, archiving and/or managing safety labels are described.

Safety labels perform a critical safety function in a variety of industrial settings. Furthermore, the law may require the display of certain safety labels to warn workers of particular hazards. Common hazards which may require a safety label include high voltage lines, pinch points, toxic and/or flammable chemicals, scaffolds and ladders, and hot surfaces, to name a few. Industrial sites, such as manufacturing plants, may include a wide array of these types of hazards and thus may require extensive safety labeling. Each such safety labels deployed in the field must be periodically replaced, either due to wear and tear or due to revisions in the laws regulating safety labels.

Known methods of managing safety labels at industrial sites are not entirely satisfactory for the range of applications in which they are employed. For example, existing methods of auditing, replacing and managing a backstock of safety labels rely on in-the-field visual observation and periodic reordering of each type of safety label. In addition, conventional safety label management methods do not provide an efficient means of determining if a particular safety label is compliant with current regulations.

Thus, there exists a need for safety label management systems that improve upon and advance the design of known safety label management systems. Examples of new and useful safety labeling management systems relevant to the needs existing in the field are discussed below.

### SUMMARY

In one embodiment, a safety label management system includes a mobile device comprising a camera, a label database, a safety label printer configured to print safety labels, and a computing unit in electronic communication with the mobile device, the label database, and the safety label printer. The mobile device may be configured to capture, via the camera, an image of an existing safety label. The label database may store a plurality of database entries, each entry including a unique label ID number, a set of label characteristics, and a printable label file. The computing unit may be configured to: process the image to identify label characteristics of the existing safety label; compare the label characteristics of the existing safety label to the label characteristics of the label database entries; and prompt a user to perform an action.

### BRIEF DESCRIPTION OF THE DRAWINGS

FIG. 1 is a schematic view of an example of a programmable computing device.

FIG. 2 is a schematic view of an example of a mobile electronic device.

FIG. 3 is an illustration of a first embodiment of a safety label.

FIG. 4. is an illustration of a second embodiment of a safety label.

FIG. 5 is shows two different embodiments of safety labels, each of which warns against the same hazard.

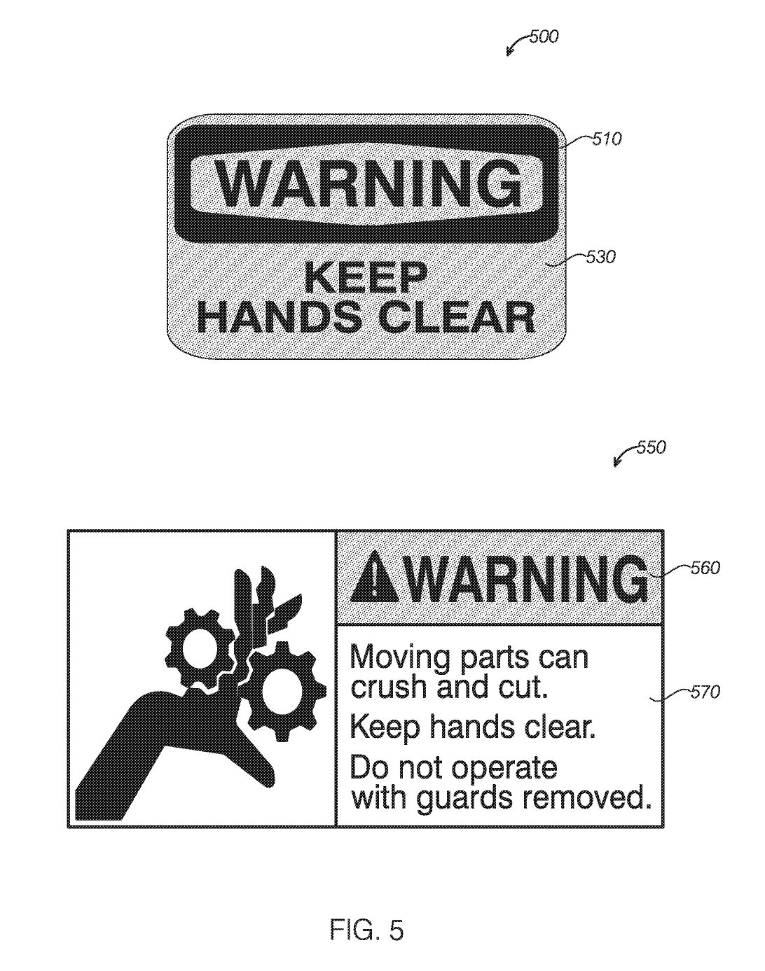

FIG. 6 is an illustration of a first embodiment of a safety label management system.

FIG. 7 is an illustration of a one embodiment of a safety label database.

FIG. 8 is an illustration of a second embodiment of a safety label management system.

### DETAILED DESCRIPTION

The disclosed safety label management systems and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of safety label management systems and methods examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

As described below, in some embodiments, the safety label management methods of the present application may be employed to control or interact with one or more computing devices. In this regard, it will be appreciated that various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

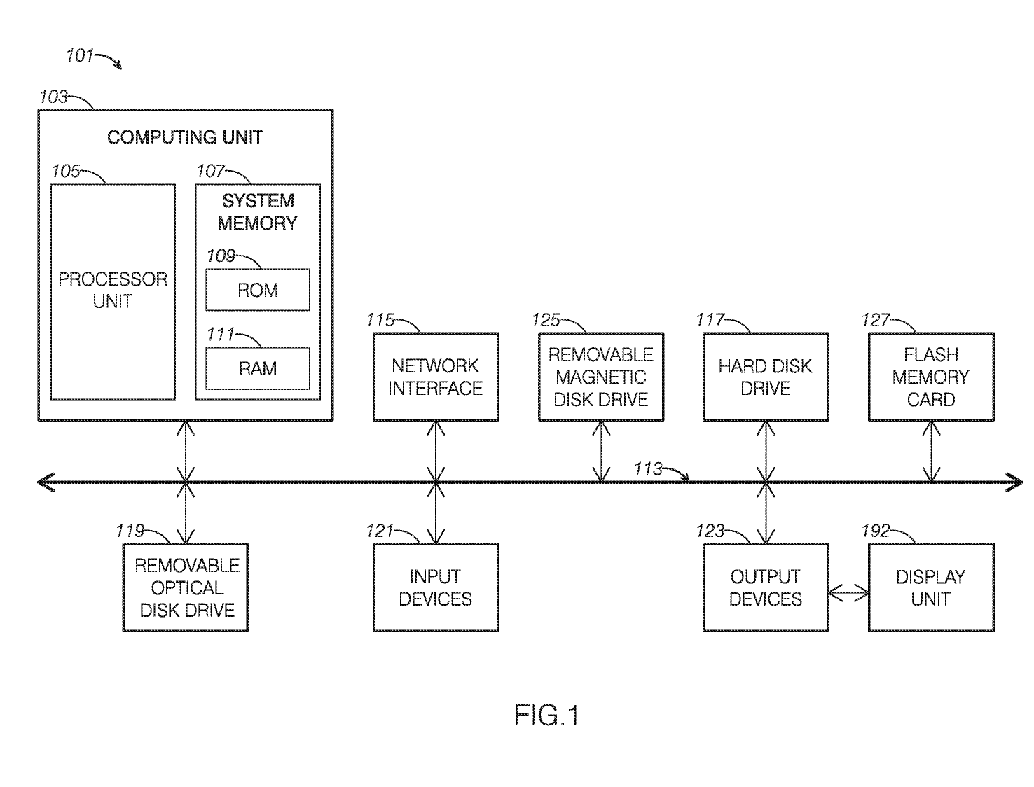

Accordingly, FIG. 1 shows one illustrative example of a computing device, computing device 101, which can be used to implement various embodiments of the invention. Computing device 101 may be incorporated within a variety of consumer electronic devices, such as personal media players, cellular phones, smart phones, personal data assistants, global positioning system devices, smart eyewear, smart watches, other computer wearables, and the like.

As seen in this figure, computing device 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123.

Output devices 123 may include, for example, a monitor display, an integrated display 192, television, printer, stereo, or speakers. Input devices 121 may include, for example, a keyboard, touch screen, a remote control pad, a pointing device (such as a mouse, touchpad, stylus, trackball, or joystick), a scanner, a microphone, a humidity sensor, an ambient light sensor, a GPS (global positioning system) receiver, one or more LPS (local positioning system) receivers, such as a WiFi receiver, a relative humidity sensor, or a camera.

More specifically, in the presently described label management systems, input devices 121 include at least a camera 122 (e.g., a light camera, a thermographic camera, etc.). In one example, camera 122 is a visible light digital camera. The visible light digital camera uses an optical system including a lens and a variable diaphragm to focus light onto an electronic image pickup device. The visible light digital camera can be a compact digital camera, a bridge camera, a mirrorless interchangeable-lens camera, a modular camera, a digital single-lens reflex camera, digital single-lens translucent camera, line-scan camera, etc. Further, it will be appreciated that the visible light digital camera can be any known or yet to be discovered visible light digital camera.

In one embodiment, camera 122 is integral to the computing device 101. In another embodiment, camera 122 is remote of the computing device 101.

As mentioned above, camera 122 can additionally or alternatively be a thermographic camera or infrared (IR) camera. The IR camera can detect heat radiation in a way similar to the way an ordinary camera detects visible light. This makes IR cameras useful for label management in “normal light”, “low light”, and/or “no light” conditions. The IR camera can include cooled infrared photodetectors (e.g. indium antimonide, indium arsenide, mercury cadmium telluride, lead sulfide, lead selenide, etc.) and/or uncooled infrared photodetectors (e.g., vanadium oxide, lanthanum barium manganite, amorphous silicon, lead zirconate titanate, lanthanum doped lead zirconate titanate, lead scandium tantalate, lean lanthanum titanate, lead titanate, lead zinc niobate, lead strontium titanate, barium strontium titanate, antimony sulfoiodide, polyvinylidene difluoride, etc.). Further, it will be appreciated that the IR camera can be any known or yet to be discovered thermographic camera.

In one embodiment, input devices 121 may include one or more temperature sensors, such as, for example a thermocouple, thermistor and/or silicon bandgap temperature sensor, among others.

Returning to FIG. 1, computing unit 103 can be directly or indirectly connected to one or more network interfaces 115 for communicating with a network. This type of network interface 115, also sometimes referred to as a network adapter or network interface card (NIC), translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

Computing device 101 may be connected to or otherwise comprise one or more other peripheral devices. In one example, computing device 101 may comprise a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc.

Of course, still other peripheral devices may be included with or otherwise connected to a computing device 101 of the type illustrated in FIG. 1, as is well known in the art. In some cases, a peripheral device may be permanently or semi-permanently connected to computing unit 103. For example, with many computing devices, computing unit 103, hard disk drive 117, removable optical disk drive 119 and a display are semi-permanently encased in a single housing.

Still other peripheral devices may be removably connected to computing device 101, however. Computing device 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computing device 101 may include a wireless dam “port,” such as a Bluetooth® interface, a Wi-Fi interface, an infrared data port, or the like.

It will be appreciated that a computing device employed according various examples of the invention may include more components than computing device 101 illustrated in FIG. 1, fewer components than computing device 101, or a different combination of components than computing device 101. Some implementations of the invention, for example, may employ one or more computing devices that are intended to have a very specific functionality, such as a server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer, tablet and/or smartphone. These computing devices may have any combination of peripheral devices or additional components as desired.

In many examples, computing devices may comprise mobile electronic devices, such as smart phones, smart glasses, tablet computers, or portable music players, often operating the iOS, Symbian, Windows-based (including Windows Mobile and Windows 8), or Android operating systems.

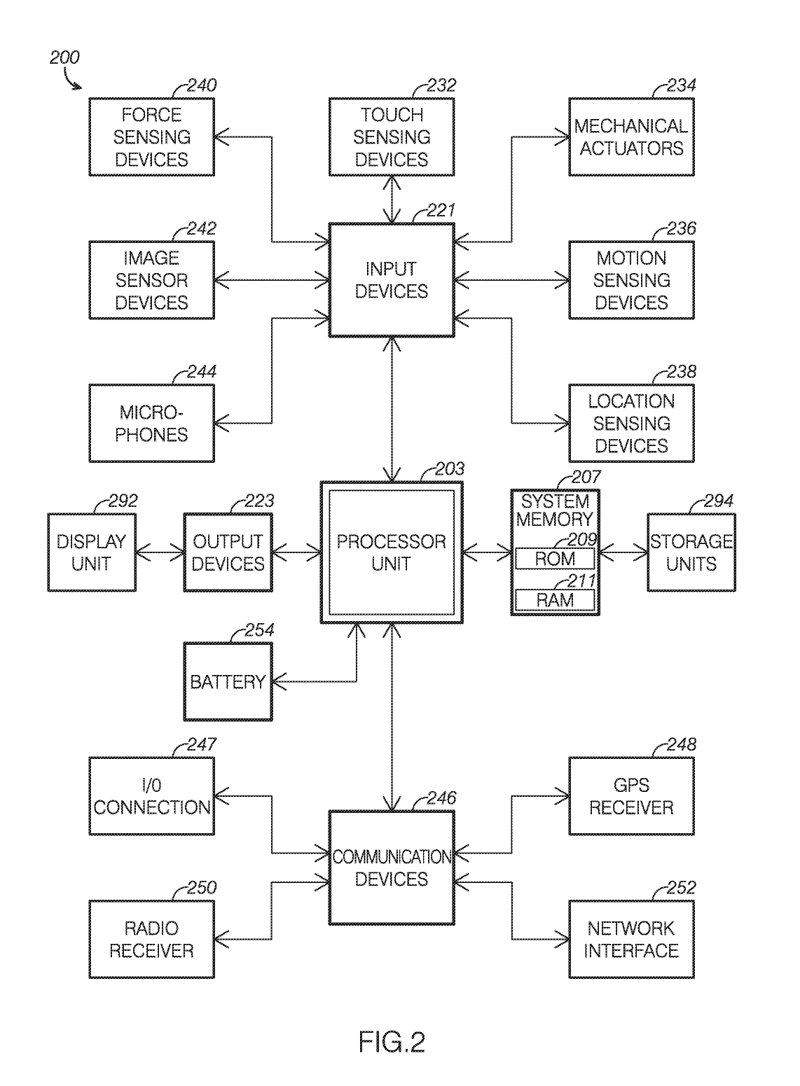

With reference to FIG. 2, an exemplary computing device, mobile device 200 is shown. Thus, mobile computing device 200 may include similar or identical features to computing device 101. In one example, mobile computing device 200 may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well-known operating systems such iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include touch sensing devices 232 such as touch screens, touch pads and touch sensing surfaces, mechanical actuators 234 such as button or wheels or hold switches, motion sensing devices 236 such as accelerometers, location detecting devices 238 such as global positioning satellite transmitters, WiFi based location detection functionality, or cellular radio based location detection functionality, force sensing devices 240 such as force sensitive displays and housings, image sensors 242 such as light cameras and/or IR cameras, and microphones 244. Input devices 221 may also include a clickable display actuator.

More specifically, in the presently described label management systems, input devices 221 include at least a camera 243 (one of image sensing devices 242). Camera 243 can be a visible light camera and/or a thermographic camera, such as those described above in reference to camera 122. Accordingly, camera 243 may have the same functions and capabilities as those described above in reference to camera 122.

Returning to FIG. 2, mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations described above can be used alone or in various combinations with the label management methods disclosed herein. The methods disclosed herein can be implemented by software, hardware or a combination of hardwire and software. The methods can also be embodied as computer readable code on a computer readable medium (e.g. a non-transitory computer readable-storage medium). The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

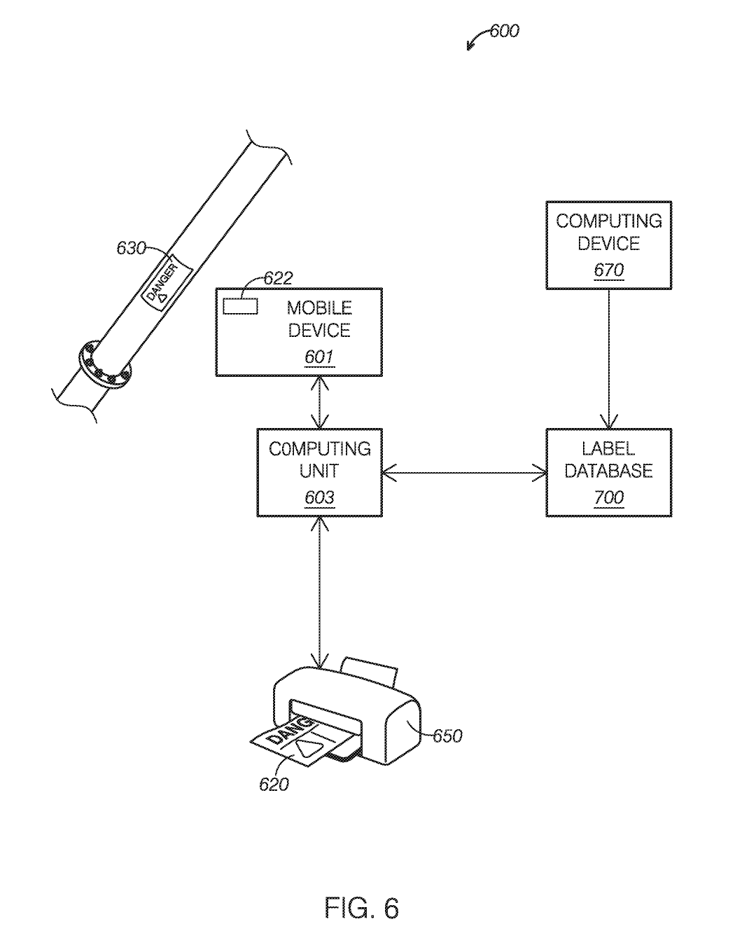

With reference to FIG. 6 a first example of a safety label management system 600 will now be described. Safety label management system 600 functions to identify, catalogue, update, audit, revise and/or replace safety labels.

Safety label management system 600 addresses many of the shortcomings existing with conventional safety label management systems. For example, safety label management system 600 automatically audits and replicates worn or outdated safety labels. Furthermore, safety label management system 600 allows a user to determine in the field if a safety label is compliant with current regulations.

As shown in FIG. 6, safety label management system 600 includes a mobile device 601, a computing unit 603, a label database 700 and a safety label printer 650. In some embodiments, safety label management system 600 includes optional remote computing device 670.

As can be seen in FIG. 6, mobile device 601 includes camera 622. In some embodiments, mobile device 601 may include one or more of the features of exemplary computing device 101 and/or exemplary mobile computing device 200. Similarly, in some embodiments, camera 622 may include one or more of the features of exemplary camera 243. Thus, for the sake of brevity, each feature of mobile device 601 and camera 622 will not be redundantly explained.

In some embodiments, computing unit 603 is integral with mobile device 601. In other embodiments, computing unit 603 is remote of mobile device 601. For example, computing unit 603 may be located in a separate computing device located in another part of the plant or on an external server.

In some embodiments, label database 700 is integral with mobile device 601. In other embodiments, label database 700 is remote of mobile device 601. For example, label database 700 may be located in a separate computing device located in another part of the plant or on an external server.

Camera 622 is configured to capture an image of an existing safety label 630 in response to input from a human user of safety label management system 600. In the illustrated embodiment, the existing label is located in-the-field, e.g., attached to an uninsulated steam pipe. In other embodiments the existing safety label may be located in storage or elsewhere. In some embodiments, the image captured by camera 622 may include environmental clues such as pipes, exit doors, a barrel or tote, hoisting or lifting equipment, and/or ladders. The presence in the image of one or more such label environment data may be useful in processing the image by safety label management system 600.

In some embodiments mobile device 601 may query the user to input his location in the plant. Such location information may be useful in processing the image by safety label management system 600. In other embodiments, the mobile device 601 may automatically sense its own location via a transmitter, e.g., a GPS transmitter. In some embodiments, mobile device 601 may determine its location via one or more transmitting beacons located in the plant. For example, mobile device 601 may determine its location via one or more beacons that utilize BLUETOOTH transmitters. In one embodiment, a beacon may transmit a unique beacon identifier. The unique beacon identifier may be received by mobile device 601 and correlated to a location in the plant.

As can be seen in FIG. 6, mobile device 601 is in electronic communication with computing unit 603. In some embodiments, computing unit 603 may include one or more of the features of exemplary computing unit 103. Thus, for the sake of brevity, each feature of computing unit 603 will nor be redundantly explained.

Computing unit 603 is configured to process the image of existing safety label 630. In some embodiments, processing the image comprises identifying label characteristics of safety label 630. In some embodiments, processing the image includes identifying one or more label layout elements. In some embodiments, processing the image may include identifying and decoding optical encoded tags. In some embodiments, processing the image may include performing object recognition of any label environment data.

Label characteristics which may be identified via the image processing step include overall label shape, overall label dimensions, color(s) of the background, color(s) of the header, word(s) in the header, pictograms, key words located in the written warning field, and/or color(s) of the text in the written warning field, among others.

Label layout elements which may be identified via the image processing step include the spatial arrangement of label characteristics on the label, color scheme(s) (e.g., red lettering with a yellow border) of the safety label, and relative sizes of label characteristics, among others.

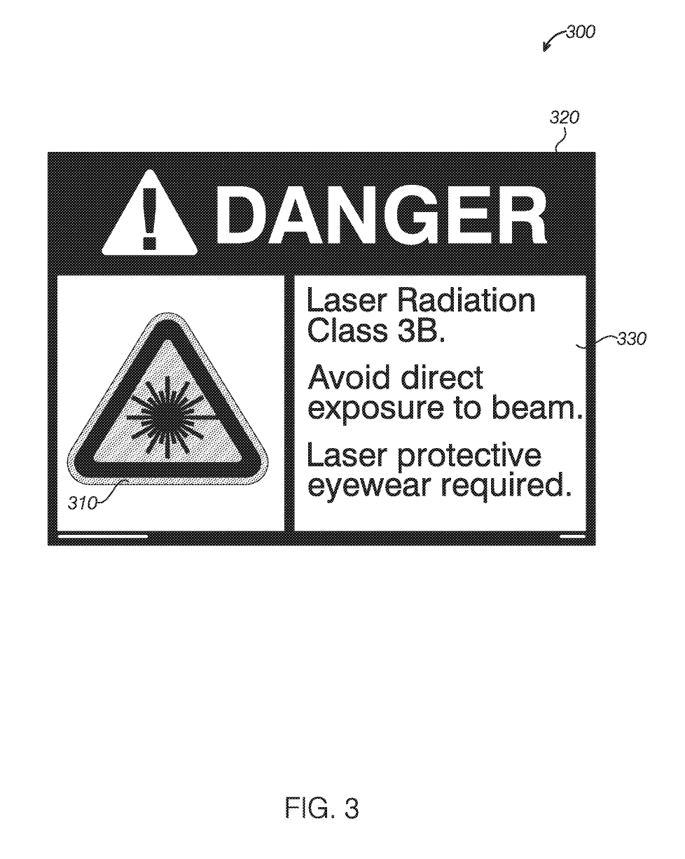

Turning now to FIG. 3, a first example of an image of a safety label 300 is shown. Safety label 300 includes header 320, pictogram 310, and a written warning located in written warning field 330. As described above, image processing may include identifying such label characteristics as the color and words of the header, pictograms and/or key words in the written warning field. In one embodiment, image processing of label 300 in accordance with the invention may produce label characteristics including the identification of a red header color, the word “DANGER” in the header, a laser pictogram, and the key words “laser”, “radiation”, and “beam”.

In another embodiment, image processing of label 300 in accordance with the invention may result in identification of label layout elements including a square pictogram field on the left, adjacent to a rectangular written warning field on the right, and a header located above.

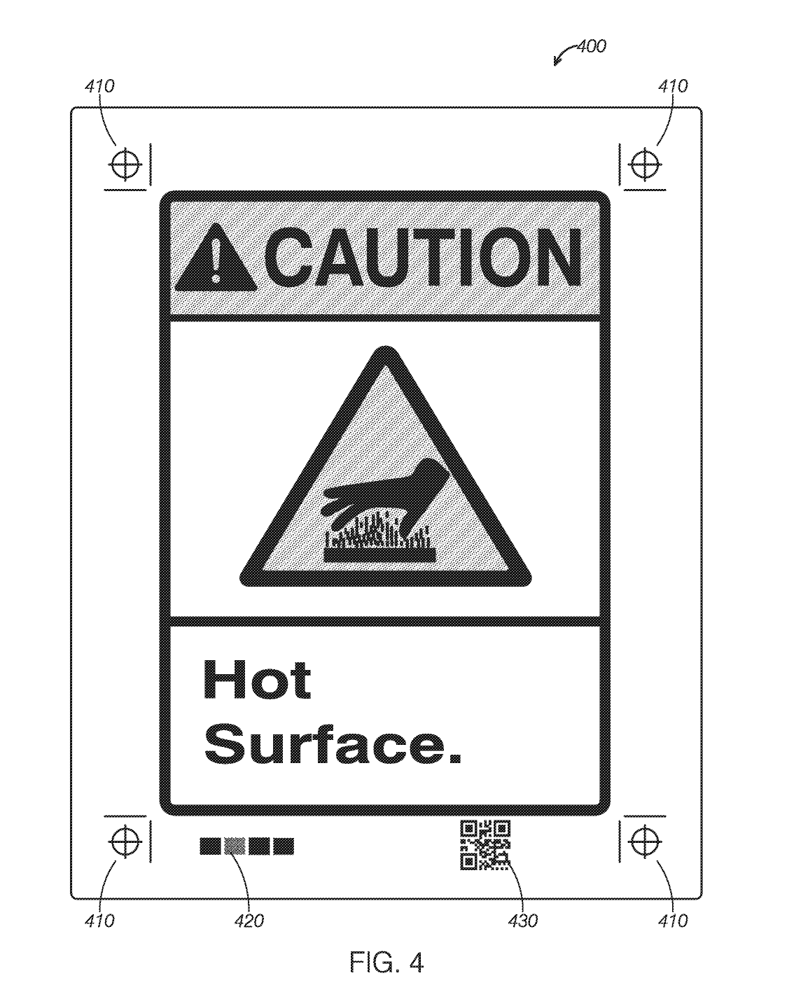

Turning now to FIG. 4, a second example of an image of a safety label 400 is shown. Safety label 400 includes registration marks 410, color strip 420, and QR code 430. As described above, image processing may include identifying such label characteristics as overall dimensions and color(s). In some embodiments, the dimensions of safety label 400 may be identified via registration marks. For example, computing unit 603 may be configured to compare the size of the registration marks in the image to a known (e.g., stored in data storage accessible by the computing unit) size of the registration marks. Furthermore, in the case that the image may exhibit skew or other distortion, registration marks 410 may be used by computing unit 603 to adjust the image.

In other embodiments, the size of the label may be determined by bouncing a signal from a transmitter of mobile device 601 off of the label and receiving the signal via a receiver of mobile device 601. In this regard, the distance from the label to mobile device may be determined and the relative size of the label may be triangulated by the computing unit 603. In still other embodiments, the size of the label may be determined by placing a marker of a known size in the frame of the image. The known size of the marker may then be used in much the same way as registration marks 410.

In some embodiments, color strip 420 may aid in identification of different colors of the label. For example, low light or false light conditions may cause the colors of the image to be distorted. In tins regard, the colors of color strip 420 in the captured image may be compared to known colors in order to adjust the color of the image.

As described above, the image processing may include identifying and decoding optical encoded tags. As used herein optical encoded tags are a machine-readable tags containing optical encoded information that must be decoded via computer. Examples of optical encoded tags include QR codes and bar codes, among others. In some embodiments, optical encoded tags may encode at least a unique safety label serial number that can be used to uniquely identify the safety label. In other embodiments, optical encoded tags may encode additional information such as label characteristic information and/or information associated with regulations that are relevant to the subject matter of the safety label. Thus, in some embodiments, QR code 430 may be decoded by computing unit 603 in order to uniquely identify safety label 400. In this regard, a matching label may be directly identified in the label database 700.

In some embodiments, mobile device 601 is configured to scan for any non-visual encoded tags associated with a safety label. As used herein, non-visual encoded tags are machine-readable tags containing non-visual encoded information that must be decoded via computer. Examples of non-visual encoded tags include RFID tags and NFC tags, among others. Non-visual encoded tags may encode the same information as optical encoded tags. Thus, non-visual encoded tugs may be used to directly identify a matching label in the label database.

However, as described below, in the event that a label does not include an optical encoded tag or a non-visual encoded tag, or such tag is unreadable, a matching label may be found via one or more label characteristics.

Turning back to FIG. 6, as can be seen, computing unit 603 is in electronic communication with label database 700. Once the image of label 630 has been processed as described above, the computing unit 603 may compare one or more of the identified label characteristics to those in the database.

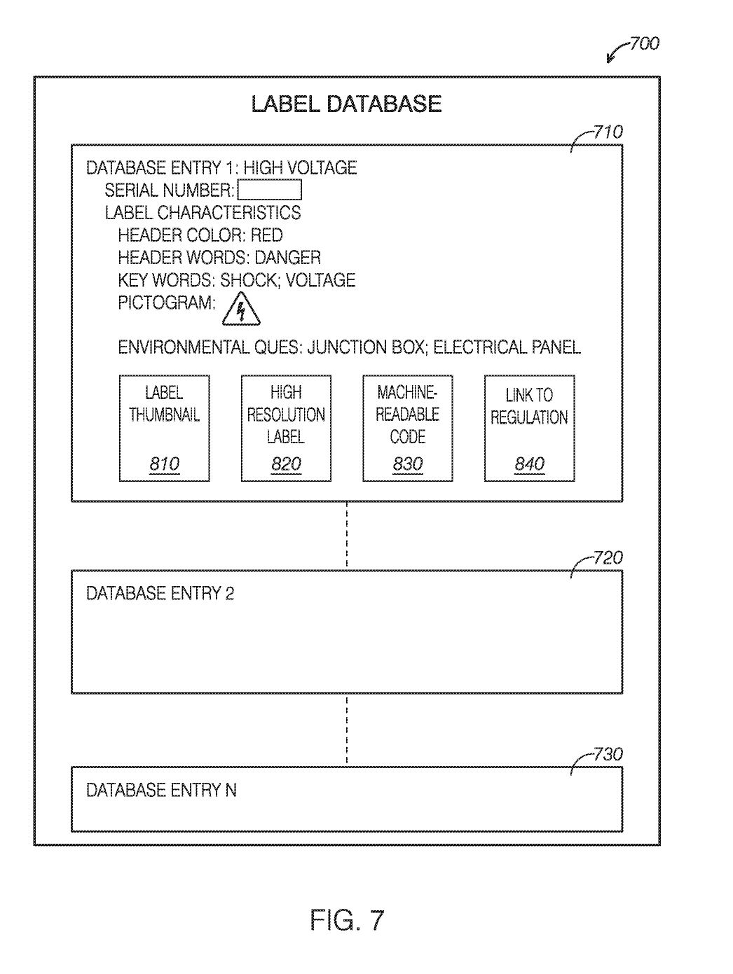

Turning now to FIG. 7, one embodiment of a label database 700 is illustrated. Label database includes a first database entry 710, a second database entry 720, and so on up to an Nth database entry 730. Exemplary first database entry 710 is an entry associated with a high voltage safety label. In the illustrated embodiment, first database entry 710 includes label characteristic information, a unique label serial number, label environment data, a thumbnail picture file 810 of the high voltage label, a high resolution picture file 820 of the label (e.g., a printable label file), an optical tag 830 and a link to relevant regulations.

Thus, in the illustrated embodiment of FIG. 7, the computing unit 603 may compare one or more of the identified label characteristics to those in first database entry 710 to look for a match. If no match is found, computing unit 603 may compare one or more of the identified label characteristics to those in second database entry 720, and so on all the way through the Nth database entry 730.

In some embodiments, if a match is found, an image of the matched label (e.g., thumbnail picture file 810) from the database may be displayed to the user on a display of the mobile device. In some embodiments, the user may then select the matched label and print a new version 620 of existing label 630 via label printer 650.

In some embodiments, it more than one match is found (due to, for example, the use of relatively few label characteristics being used to search for a match), then the results may be prioritized first by pictograms, then by key words and then by other label characteristics.

In some embodiments, the computing unit 603 may use location information gathered by mobile device 601, as described above, to limit the scope of the database entries that must be searched. For example, an indication that the user is in a warehouse may limit the possible safety labels in the database to those hazards that are present in the warehouse, such as flammable liquids and hoisting machinery.

As described above, exemplary database entry 710 may include a link 840 to relevant regulations concerning the label. In some embodiments, link 840 is a web link to an external website. In other embodiments, link 840 is a link to the regulations stored in an onsite database. In some embodiments, mobile device 601 is configured to display the regulations in response to a matching label being found in the label database 700.

In some embodiments, the system 600 may include a suggestion engine. The suggestion engine may aid in finding a match for the image of label 630 and/or speed response times. The suggestion engine may query the user for input such as the nature of the hazard, the user's location, and/or the type of machine or substance, among others. In this regard, the number of possible safety labels that must be searched in the database may be limited.

In some embodiments, if no match is found the user may be prompted via mobile device 601 to save the label as a new database entry in label database 700. The new database entry may include one or more of: label characteristic information, unique label serial number, label environment data, thumbnail picture file of the label, a high resolution picture file of the label, an optical tag, and a link to relevant regulations.

Furthermore, in some embodiments, mobile device 601 and/or remote computing device 670 may be configured to allow the user to build a new database entry without capturing an image of an existing label. In this regard, a user may design a new label, via mobile device 601 and/or remote computing device 670. Next the user may add, via mobile device 601 and/or remote computing device 670, such information as label environment data and link(s) to relevant regulations. Mobile device 601 and/or remote computing device 670 may then create a new database entry including relevant label characteristic information, unique label serial number, thumbnail picture file of the label, a high resolution picture file of the label, and/or an optical tag.

In some embodiments, the system 600 may generate automatic notifications to the user that a label needs to be replaced. Such notifications may be based on a preset expiration for the label or based on updates at the label database indicating that the regulations have expired.

In some embodiments, one or more reports may be generated based on the information contained in label database 700. For example, a report of the hazards present on the site may be generated at remote computing device 670, for inspection or training purposes.

Thus, as described above, the system 600 may be useful in asset management. As used herein, asset management refers to any system that monitors and maintains things of value to an entity or group. It may apply to both tangible assets such as buildings and to intangible assets such as human capital, intellectual property, and goodwill and financial assets. Asset management is a systematic process of deploying, operating, maintaining, upgrading, and disposing of assets cost-effectively.

In some embodiments, system 600 may be implemented in an infrastructure asset management system. Infrastructure asset management is the combination of management, financial, economic, engineering, and other practices applied to physical assets with the objective of providing the required level of service in the most cost-effective manner. It includes the management of the entire lifecycle—including design, construction, commissioning, operating, maintaining, repairing, modifying, replacing and decommissioning/disposal—of physical and infrastructure assets.

In some embodiments, at least some of the database entries in the label database may include one or more foreign language versions of the safety label. In some embodiments, mobile device is configured to identify text in one or more foreign languages.

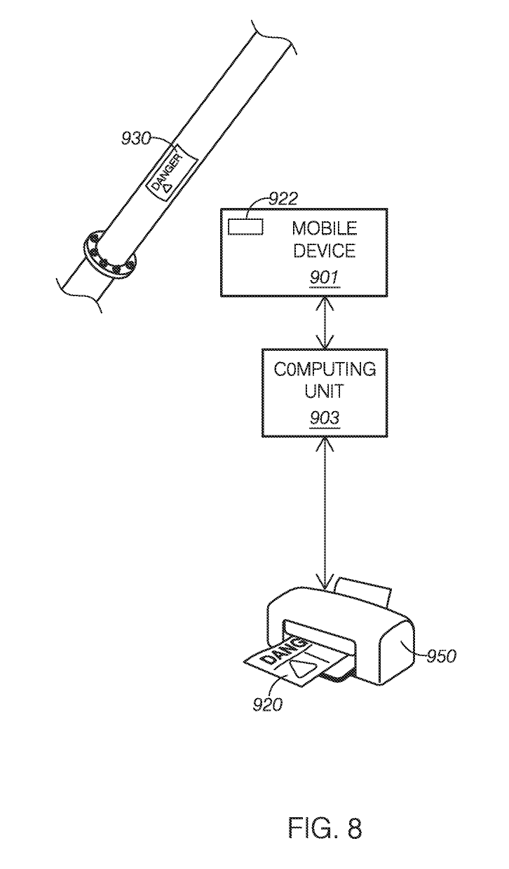

Turning now to FIG. 8, a second embodiment a of a safety label management system, system 900 is illustrated. Safety label management system 900 may include one or more of the features of safety label management system 600. Thus, for the sake of brevity, each feature of safety label management system 900 will not be redundantly explained.

Safety label management system 900 includes a mobile device 901, a computing unit 903, and a safety label printer 950. Computing unit 903 includes camera 922. Camera 922 may include one or more of the features of camera 622. Thus, for the sake of brevity, each feature of camera 922 will not be redundantly explained.

Camera 922 is configured to capture an image of an existing safety label 930 in response to input from a human user of safety label management system 900. Computing unit 903 is configured to process the image of existing safety label 930. Processing the image may include identifying label characteristics and or label layout elements of safety label 930.

Next, computing unit 903 may replicate the identified label characteristics and/or label layout elements of existing safety label 930, thereby creating a new label file. Computing unit 903 may also update one or more of the identified label characteristics and/or label layout elements. For example, computing unit 903 may identify an outdated pictogram in the image of existing safety label 930, and in response, select a current pictogram to include in the new label file.

The user may then examine the new label file, via a display of computing unit 903. The user may and print the new label file, thus creating a new version 920 of existing label 930 via label printer 950.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A safety label management system comprising:
a mobile device comprising a camera;
wherein the mobile device is configured to capture, via the camera, an image of an existing safety label;
a label database;
wherein the label database stores a plurality of database entries, each entry comprising a unique label ID number, a set of label characteristics, and a printable label file;
a safety label printer configured to print safety labels;
a computing unit in electronic communication with the mobile device, the label database, and the safety label printer;
wherein the computing unit is configured to:
process the image to identify label characteristics of the existing safety label;
compare the label characteristics of the existing safety label to the label characteristics of the label database entries; and
prompt a user to perform an action.

2. The safety label management system of claim 1, wherein the mobile device is configured to obtain label environment data relating to the environment surrounding the existing safety label.

3. The safety label management system of claim 2, wherein the label environment data includes at least one of: location coordinates of the existing safety label, ambient light near the existing safety label, temperature near the existing safety label, and relative humidity near the existing safety label.

4. The safety label management system of claim 2, wherein the mobile device comprises a locating device.

5. The safety label management system of claim 4, wherein the locating device includes at least one of: a GPS (Global Positioning System) receiver, and a LPS (Llobal Positioning System).

6. The safety label management system of claim 2, wherein the mobile device comprises a temperature sensor.

7. The safety label management system of claim 2, wherein the mobile device comprises an ambient light sensor.

8. The safety label management system of claim 2, wherein the mobile device comprises a relative humidity sensor.

9. The safety label management system of claim 1, wherein the action is to print, via the safety label printer, a replacement label for the existing safety label.

10. The safety label management system of claim 1, wherein the action comprises sending an instruction to shut down a machine associated with the existing safety label.

11. The safety label management system of claim 1, wherein the action comprises creating a new database entry for the existing safety label.

12. The safety label management system of claim 1, wherein the action comprises sending a raw material order to a third party, wherein the raw material is associated with the existing safety label.

13. The safety label management system of claim 1, wherein the label characteristics in the label database entries include one or more of: color of a label header, words of a label header, pictograms of a label, registration marks, and a QR code.

14. The safety label management system of claim 1, wherein the computing unit is configured to:
generate a unique label ID tor the existing safety label, wherein the unique ID is a string of alphanumeric characters, and wherein groups of decimal places within the string of alphanumeric characters are associated with different categories of label characteristics
compare the label characteristics of the existing safety label to the label characteristics of the label database entries by comparing the unique label ID of the existing safety label to the unique label IDs of database entries.

15. A safety label management system comprising:
a mobile device comprising a camera;
wherein the mobile device is configured to capture, via the camera, an image of an existing safety label;
wherein the mobile device is configured to obtain label environment data relating to the environment surrounding the existing safety label
a label database:
wherein the label database stores a plurality of database entries, each entry comprising a unique label ID number, a set of label characteristics, and a printable label file;
a safety label printer configured to print safety labels;
a computing unit in electronic communication with the mobile device, the label database, and the safety label printer;
wherein the computing unit is configured to:
process the image to identify label characteristics of the existing safety label;
compare the label characteristics of the existing safety label to the label characteristics of the label database entries; and
prompt a user to perform an action.

16. The safety label management system of claim 15, wherein the label environment data includes at least one of: location coordinates of the existing safety label, ambient light near the existing safety label, temperature near the existing safety label, and relative humidity near the existing safety label.

17. The safety label management system of claim 15, wherein the mobile device comprises a locating device.

18. The safety label management system of claim 2, wherein the mobile device comprises a temperature sensor.

19. The safety label management system of claim 2, wherein the mobile device comprises an ambient light sensor.

20. The safety label management system of claim 2, wherein the mobile device comprises a relative humidity sensor.
